(19) United States
(12) Patent Application Publication
(10) Pub. No.: US 2026/0295675 A1
(43) Pub. Date: Oct. 1, 2026

(54) METHOD FOR MANUFACTURING LAYERED STRUCTURE

(71) Applicants: TAIYO NIPPON SANSO CORPORATION, Tokyo (JP); OSAKA UNIVERSITY, Suita-shi, Osaka (JP)

(72) Inventors: Hiroki AMANO, Tokyo (JP); Tomohiro OYAMA, Tokyo (JP); Tomoaki SASAKI, Tokyo (JP); Keisuke AIBA, Tokyo (JP); Takayoshi NAKANO, Suita-shi (JP); Takuya ISHIMOTO, Suita-shi (JP)

(21) Appl. No.: 18/881,534

(22) PCT Filed: Jul. 6, 2023
(86) PCT No.: PCT/JP2023/025085

§ 371 Date: Jan. 6, 2025

(30) Foreign Application Priority Data
Jul. 13, 2022 (JP) 2022-112289

(51) Int. Cl. B22F 10/28; B22F 10/36; B22F 10/37; B22F 10/38; B33Y 10/00; B33Y 40/00

(52) U.S. Cl. CPC B22F 10/28; B22F 10/36; B22F 10/37; B22F 10/38; B33Y 10/00; B33Y 40/00; B22F 2202/11

(57) ABSTRACT

An object of the present invention is to provide a manufacturing method for a layered structure that allows easy control of the crystallographic texture in the layered structure. The present invention provides a manufacturing method for a layered structure including the steps of: providing a gas flow parallel to the surface of a powder bed; forming the first melt-solidified layer by scanning and irradiating an energy beam in a first direction; and forming the second melt-solidified layer by scanning and irradiating an energy beam in a second direction which intersects the first direction; wherein a residual thickness of the first melt-solidified layer and a residual thickness of the second melt-solidified layer in the crystallographic texture are controlled by the steps of: adjusting a first accumulation thickness of the powder bed and a first heat input amount of the energy beam to control a layer thickness and a penetration depth of the first melt-solidified layer; and adjusting a second accumulation thickness of the powder bed and a second heat input amount of the energy beam to control a layer thickness and a penetration depth of the second melt-solidified layer; and wherein the first heat input amount is controlled by adjusting an angle α1 between the first direction and a direction of the gas flow, and the second heat input amount is controlled by adjusting an angle α2 between the second direction and the direction of the gas flow.

### TECHNICAL FIELD

The present invention relates to a method for manufacturing a layered structure.

### BACKGROUND ART

A layered structure may be manufactured using an energy beam, as in additive manufacturing technology. For example, a layered structure of any shape can be manufactured as a three-dimensional structure by sequentially layering metal layers obtained by irradiating a laser based on any CAD (Computer-Aided Design) data. Additive manufacturing technology is applied to industrial equipment fields including aircraft-related parts and medical equipment fields, and is attracting attention as a promising technology. In recent years, it has been proposed to control the crystallographic texture of the layered structure in order to impart desired mechanical properties to the layered structure. For example, the mechanical strength and elastic modulus can be controlled by controlling the crystallographic texture. In addition, anisotropy in mechanical properties such as Young's modulus, yield stress, and fatigue resistance can be imparted to the layered structure by having a crystallographic texture having a preferential crystal direction.

Patent Documents 1 to 3 propose adjusting process parameters such as laser scanning speed, laser power, hatch distance, and scanning strategy as a method for controlling the crystallographic texture.

Patent Document 1 proposes controlling the crystal orientation by adjusting the scanning direction in the melting process in order to achieve a low elastic modulus in a β titanium alloy.

Patent Document 2 proposes forming a single crystalline-like texture in the layering direction by combining a scanning strategy with laser power and controlling the irradiation direction and power of the laser light and/or arc discharge.

Patent Document 3 proposes obtaining a single crystalline-like texture by guiding a beam from a directed energy source, performing deposition and fusion processes, and re-melting and solidification using a separate external thermal control device.

On the other hand, Patent Document 4 discloses an additive manufacturing method in which a gas flow is provided near the surface of a powder bed to remove fumes generated when a metal layer is formed by irradiating a laser, and the gas flow direction can be switched depending on the scanning direction of the laser.

### PRIOR ART DOCUMENTS

### Patent Documents

Patent Document 1: Japanese Unexamined Patent Application, First Publication No. 2017-171985
Patent Document 2: Japanese Unexamined Patent Application, First Publication No. 2018-115090
Patent Document 3: Japanese Patent (Granted) Publication No. 6216881
Patent Document 4: Japanese Unexamined Patent Application, First Publication No. 2019-183282

### SUMMARY OF INVENTION

### Problem to be Solved by the Invention

However, as disclosed in Patent Document 4, when a layered structure is manufactured by forming a metal layer by irradiating a laser while providing a gas flow near the surface of a powder bed and layering the metal layers, it was difficult to control the crystallographic texture in the layered structure by simply adjusting process parameters such as the laser scanning speed, laser power, hatch distance, and scanning strategy, as disclosed in Patent Documents 1 to 3.

The present invention has been made in view of the above circumstances, and an object of the present invention is to provide a manufacturing method for a layered structure that allows easy control of the crystallographic texture in the layered structure.

### Means for Solving the Problem

As a result of intensive research, the inventors of the present application have found that as the laser scanning direction and the gas flow direction become the same direction (i.e., parallel directions), in other words, as an angle α between the laser scanning direction and the gas flow direction approaches 0°, spatters and fumes generated when the raw material powder is melted by laser irradiation flow in the laser scanning direction due to the gas flow, causing laser attenuation in the scanning direction and reducing the heat input amount of the laser. They also found that the gas flows in the longitudinal direction of the molten pool, promoting heat dissipation from the molten raw material, and completed the present invention.

In order to solve the above problems, the present invention has the following aspects.

[1] A manufacturing method for a layered structure including at least one first melt-solidified layer and at least one second melt-solidified layer, and including crystallographic texture in which the at least one first melt-solidified layer and the at least one second melt-solidified layer are layered in a thickness direction, including the steps of:
providing a gas flow parallel to the surface of a powder bed on which raw material powder is deposited;
forming the first melt-solidified layer by scanning and irradiating an energy beam in a first direction which is parallel to the surface of the powder bed; and
forming the second melt-solidified layer by scanning and irradiating an energy beam in a second direction which is parallel to the surface of the powder bed and intersects the first direction;
wherein a residual thickness of the first melt-solidified layer and a residual thickness of the second melt-solidified layer in the crystallographic texture are controlled by the steps of:
when forming the first melt-solidified layer, adjusting a first accumulation thickness of the powder bed and a first heat input amount of the energy beam irradiated to the powder bed to control a layer thickness of the first melt-solidified layer and a penetration depth of the first melt-solidified layer; and
when forming the second melt-solidified layer, adjusting a second accumulation thickness of the powder bed and a second heat input amount of the energy beam irradiated to the powder bed to control a layer thickness of the second melt-solidified layer and a penetration depth of the second melt-solidified layer; and
wherein the first heat input amount is controlled by adjusting an angle α1 between the first direction and a direction of the gas flow, and the second heat input amount is controlled by adjusting an angle α2 between the second direction and the direction of the gas flow.

[2] The manufacturing method for a layered structure according to [1],
wherein one of the angles α1 and α2 is adjusted to 45° or more and 90° or less, and the other is adjusted to 0° or more and 45° or less.

[3] The manufacturing method for a layered structure according to [1] or [2],
wherein the layered structure includes only the first melt-solidified layer or the second melt-solidified layer, and
wherein the layered structure further includes a crystallographic texture in which multiple first melt-solidified layers are layered or multiple second melt-solidified layers are layered in the thickness direction.

[4] The manufacturing method for a layered structure according to any of [1] to [3],
wherein the manufacturing method further includes:
irradiating an energy beam while scanning in a third direction that is parallel to the surface of the power bed and intersects with the first direction and the second direction to produce a third melt-solidified layer, and manufacturing a layered structure which includes at least one third melt-solidified layer and which further includes a crystallographic texture in which multiple third melt-solidified layers are layered in the thickness direction.

### Effects of the Invention

The manufacturing method of a layered structure of the present invention makes it easy to control the crystallographic texture in the layered structure.

### BRIEF DESCRIPTION OF THE DRAWINGS

FIG. 1 is a schematic diagram showing one embodiment of the configuration of a manufacturing apparatus for a layered structure applicable to an embodiment according to the present invention.

FIG. 2 is a plan view of a modeling stage provided in a manufacturing apparatus for a layered structure applicable to an embodiment according to the present invention.

FIG. 3 is a diagram for explaining a smallest angle between a scanning direction of an energy beam and a direction of a gas flow F in an embodiment according to the present invention.

FIG. 4 is a diagram for explaining an embodiment of a manufacturing method for a layered structure.

FIG. 5 is a diagram for explaining an embodiment of a manufacturing method for a layered structure.

FIG. 6 is a diagram for explaining a crystallographic texture of a layered structure obtained by a manufacturing method for a layered structure of an embodiment according to the present invention.

FIG. 7 is a diagram for explaining a crystallographic texture of another layered structure obtained by a manufacturing method for a layered structure of another embodiment according to the present invention.

FIG. 8 is a diagram for explaining a crystallographic texture of another layered structure obtained by a manufacturing method for a layered structure of another embodiment according to the present invention.

FIG. 9 is a diagram of a layered structure produced in Experimental Examples 1 and 2.

FIG. 10 is a diagram showing the results of observing a crystal direction map (IPF map) and pole figures of a layered structure produced in Experimental Examples 1 and 2.

FIG. 11 is a diagram showing the results of observing a crystallographic texture of a layered structure produced in Experimental Examples 1 and 2.

FIG. 12 is a diagram showing the results of observing a crystallographic texture of a layered structure produced in Experimental Example 3.

FIG. 13 is a diagram showing a relationship between an accumulation thickness of a powder bed and a depth of a molten pool in Experimental Example 3.

FIG. 14 is a diagram showing the results of observing a residual thickness (x-scan thickness) of an x-scan layer and a residual thickness (y-scan thickness) of a y-scan layer in Experimental Example 4.

FIG. 15 is a diagram showing the results of observing a residual thickness (x-scan thickness) of an x-scan layer and a residual thickness (y-scan thickness) of a y-scan layer in Experimental Example 4.

FIG. 16 is a diagram of a layered structure produced in Experimental Example 5.

FIG. 17 is a diagram showing the results of observing the crystallographic texture of a layered structure produced in Experimental Example 5.

### DETAILED DESCRIPTION OF THE PREFERRED EMBODIMENTS

### (Definitions)

In the present description, crystal planes are indicated as follows:
(001): When the axes are fixed.
{001}: When the x, y, z, and the like axes are not fixed. In this case crystal planes cannot be distinguished depending on the viewing direction.

Crystal directions are indicated as follows:
[001]: When the axes are fixed.
<001>: When the x, y, z, and the like axes are not fixed. In this case a crystal direction cannot be distinguished depending on the viewing direction.
(001), and the like represent Miller indices.

The slash “~” indicating a numerical range means that the numbers before and after are included as the lower and upper limits.

### <Manufacturing Method for Layered Structure>

A manufacturing method for a layered structure according to the present invention is a manufacturing method for a layered structure including at least one first melt-solidified layer and at least one second melt-solidified layer, and including crystallographic texture in which the at least one first melt-solidified layer and the at least one second melt-solidified layer are layered in a thickness direction, including the steps of: providing a gas flow parallel to the surface of a powder bed on which raw material powder is deposited; forming the first melt-solidified layer by scanning and irradiating an energy beam in a first direction which is parallel to the surface of the powder bed; and forming the second melt-solidified layer by scanning and irradiating an energy beam in a second direction which is parallel to the surface of the powder bed and intersects the first direction;
wherein a residual thickness of the first melt-solidified layer and a residual thickness of the second melt-solidified layer in the crystallographic texture are controlled by the steps of:
when forming the first melt-solidified layer, adjusting a first accumulation thickness of the powder bed and a first heat input amount of the energy beam irradiated to the powder bed to control a layer thickness of the first melt-solidified layer and a penetration depth of the first melt-solidified layer; and
when forming the second melt-solidified layer, adjusting a second accumulation thickness of the powder bed and a second heat input amount of the energy beam irradiated to the powder bed to control a layer thickness of the second melt-solidified layer and a penetration depth of the second melt-solidified layer; and
wherein the first heat input amount is controlled by adjusting an angle α1 between the first direction and a direction of the gas flow, and the second heat input amount is controlled by adjusting the angle α2 between the second direction and the direction of the gas flow.

In the manufacturing method according to the present invention, the layer thickness of the melt-solidified layer formed by irradiation with the energy beam and the penetration depth of the melt-solidified layer can be controlled by adjusting the heat input amount of the energy beam irradiated to the powder bed in each scanning direction of the energy beam.

Specifically, the layer thickness of the first melt-solidified layer and the penetration depth of the first melt-solidified layer can be controlled by adjusting the first heat input amount of the energy beam. Similarly, the layer thickness of the second melt-solidified layer and the penetration depth of the second melt-solidified layer can be controlled by adjusting the second heat input amount of the energy beam.

In addition, each of the first heat input amount and the second heat input amount can be controlled by adjusting the smallest angle α1 between the first direction and the gas flow direction and the smallest angle α2 between the second direction and the gas flow direction.

When the gas flow direction and the scanning direction of the energy beam are the same (that is, when the gas flow direction and the scanning direction of the energy beam are parallel), spatters and fumes which are generated when the raw material powder is melted by irradiating the powder bed with the energy beam flow in the gas flow direction, causing attenuation of the energy beam scanning in the gas flow direction and reducing the amount of heat. In addition, gas flows in the longitudinal direction of the molten pool, promoting heat dissipation from the molten raw material. Therefore, by changing the smallest angle α (α1, α2) between the scanning direction of the energy beam and the gas flow direction, the heat input amount of the energy beam irradiated to the powder bed can be adjusted, and as a result, the penetration depth of the melt-solidified layer formed by the energy beam scanned in the required direction can be controlled.

Specifically, by bringing the smallest angle α between the scanning direction of the energy beam and the gas flow direction closer to 0°, the amount of reduction in the heat input amount increases, and the penetration depth of the melt-solidified layer formed by the energy beam scanned in that direction can be reduced.

In contrast, by bringing the smallest angle α between the scanning direction of the energy beam and the gas flow direction closer to 90°, the amount of reduction in the heat input amount decreases, and the penetration depth of the melt-solidified layer formed by the energy beam scanned in that direction can be increased.

As a result, the residual thickness of the melt-solidified layer to be controlled can be changed in the crystallographic texture contained in the layered structure. Therefore, since the orientation of the crystal direction can be adjusted by changing the smallest angle α between the scanning direction of the energy beam and the gas flow direction, the crystallographic texture of the layered structure can be easily controlled.

Furthermore, the first heat input amount and the second heat input amount may each be further controlled by a scan strategy such as the power of the energy beam, the scanning speed, the hatch distance, and the irradiation position.

By controlling the heat input amount of the energy beam irradiated to the powder bed, the manufacturing method according to the present invention can vary the residual thickness of the crystallographic texture when forming the melt-solidified layer to be controlled. As a result, greater versatility can be provided in controlling the crystallographic texture of the layered structure.

In the manufacturing method according to the present invention, by adjusting the accumulation thickness of the powder bed used to form the melt-solidified layer that constitutes the crystallographic texture, it is possible to control the layer thickness of the melt-solidified layer formed by irradiation with an energy beam and the penetration depth of the melt-solidified layer.

Specifically, the layer thickness of the first melt-solidified layer can be controlled by adjusting the first accumulation thickness of the powder bed. Similarly, the layer thickness of the second melt-solidified layer can be controlled by adjusting the second accumulation thickness of the powder bed.

In addition, the first accumulation thickness of the powder bed and the second layer thickness may be the same or different.

Furthermore, in the manufacturing method according to the present invention, among the crystallographic textures constituting the layered structure, the accumulation thickness of the powder bed for the melt-solidified layer to be controlled and the accumulation thickness of the powder bed for the adjacent melt-solidified layer above and below in the thickness direction of the melt-solidified layer to be controlled can be mutually varied. Therefore, the residual thickness in the layered structure can be changed more precisely between the melt-solidified layer to be controlled and the adjacent melt-solidified layer above and below it in the thickness direction.

The “accumulation thickness of the powder bed” refers to the thickness in the direction perpendicular to the surface of the powder bed, and the “thickness direction of the melt-solidified layer” can also be the direction perpendicular to the surface of the powder bed.

Therefore, in the manufacturing method according to the present invention, the orientation of the crystal direction can be adjusted by changing the accumulation thickness of the powder bed, so that the crystallographic texture of the layered structure can be controlled more easily. In addition, for example, by sequentially layering the melt-solidified layers in the thickness direction while changing the accumulation thickness of the powder bed for each melt-solidified layer, further diversity can be provided in controlling the crystallographic texture of the layered structure.

In addition, in the manufacturing method according to the present invention, one of the smallest angle α1 between the first direction and the gas flow direction and the smallest angle α2 between the second direction and the gas flow direction may be adjusted to be greater than or equal to 45° and less than or equal to 90°, and the other may be adjusted to be greater than or equal to 0° and less than or equal to 45°.

By adjusting angles α1 and α2 to be different within the above ranges, it is possible to create a difference between the heat input amount when irradiating the energy beam while scanning in the first direction and the heat input amount when irradiating the energy beam while scanning in the second direction, without changing the power and scanning speed of the energy beam.

As a result, the penetration depth of the melt-solidified layer formed in a scanning direction with a small heat input amount is less than the penetration depth of the melt-solidified layer formed in a scanning direction with a large heat input amount. In the crystallographic texture in the layered structure formed by alternating scanning in the first direction and scanning in the second direction, the residual thickness of the melt-solidified layer formed in the scanning direction with a small heat input amount is less than the residual thickness of the melt-solidified layer formed in a scanning direction with a large heat input amount.

In contrast, by adjusting angles α1 and α2 to 45°, the heat input amount when irradiating the energy beam while scanning in the first direction and the heat input amount when irradiating the energy beam while scanning in the second direction can be adjusted to be approximately the same, without changing the power and scanning speed of the energy beam.

As a result, the penetration depth of the first melt-solidified layer and the penetration depth of the second melt-solidified layer become approximately equal. In the crystallographic texture in the layered structure formed by alternating scanning in the first direction and scanning in the second direction, the residual thickness of the first melt-solidified layer and the residual thickness of the second melt-solidified layer become approximately equal.

As a result, in the crystallographic texture contained in the layered structure, the residual thickness of the melt-solidified layer to be controlled can be adjusted to an arbitrary thickness, and further versatility can be provided in controlling the crystallographic texture of the layered structure.

Furthermore, by the manufacturing method according to the present invention, a layered structure is obtained that includes the first melt-solidified layer and the second melt-solidified layer and that includes a crystallographic texture in which the first melt-solidified layer and the second melt-solidified layer are layered alternately in the thickness direction, but the layered structure may further include a crystallographic texture that includes one first melt-solidified layer and that includes multiple layers of the first melt-solidified layer layered in the thickness direction, or a crystallographic texture that includes one second melt-solidified layer and that includes multiple layers of the second melt-solidified layer layered in the thickness direction.

Specifically, when forming a layered structure by alternately scanning in the first direction and scanning in the second direction, during the formation of the first melt-solidified layer, the first accumulation thickness of the powder bed is adjusted to be large, thereby controlling the layer thickness of the first melt-solidified layer to be large, and the first heat input amount of the energy beam irradiated to the powder bed is adjusted to be large, thereby controlling the penetration depth of the first melt-solidified layer to be large; during the formation of the second melt-solidified layer, the second accumulation thickness of the powder bed is adjusted to be small, thereby controlling the layer thickness of the second melt-solidified layer to be small, and the second heat input amount of the energy beam irradiated to the powder bed is adjusted to be small, thereby controlling the penetration depth of the second melt-solidified layer to be small. This reduces the residual thickness of the second melt-solidified layer, so that when the first melt-solidified layer is formed by irradiating the energy beam while scanning in the first direction, the second melt-solidified layer is overwritten. As a result, a crystallographic texture including only the first melt-solidified layer and multiple layers of the first melt-solidified layer in the thickness direction can be obtained. In the same manner, a crystallographic texture including only the second melt-solidified layer and multiple layers of the second melt-solidified layer in the thickness direction can be obtained.

Furthermore, the manufacturing method of the layered structure of the present invention may be a manufacturing method for a layered structure that includes at least one third melt-solidified layer and includes a crystallographic texture in which the first to third melt-solidified layers are layered in multiple layers in the thickness direction by irradiating the powder bed with an energy beam while scanning it in a third direction that is parallel to the surface of the powder bed and intersects with the first and second directions, in addition to the first and second directions described above. This allows further versatility in controlling the crystallographic texture of the layered structure.

Hereinafter, an embodiment of a manufacturing method for a layered structure according to the present will be described in detail with reference to the drawings together with a manufacturing apparatus of the layered structure used therein. Note that the drawings used in the following description may show characteristic parts in an enlarged scale for the sake of convenience in order to make the characteristics easier to understand, and the dimensional ratios of each component may not necessarily be the same as the actual ones.

### (Manufacturing Apparatus for Layered Structure)

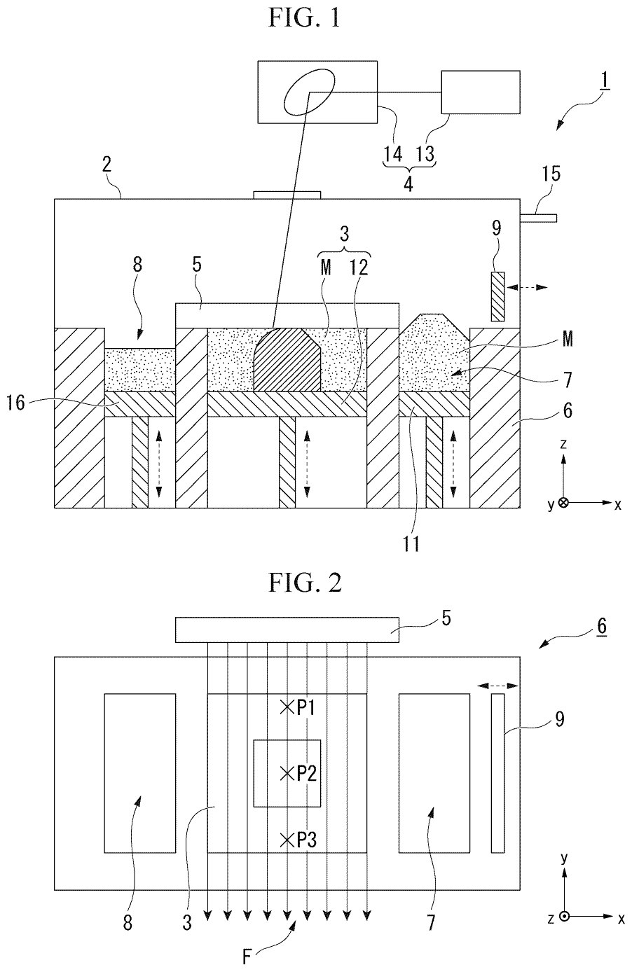

First, the configuration of a manufacturing apparatus for a layered structure applicable to an embodiment of a manufacturing method for a layered structure according to the present invention will be described. FIG. 1 is a schematic diagram showing one embodiment of the configuration of a manufacturing apparatus for a layered structure applicable to the present embodiment. FIG. 2 is a plan view of a modeling stage provided in a manufacturing apparatus for a layered structure applicable to the present embodiment.

In the manufacturing method for a layered structure of the present embodiment, an example will be described below in which a laser is used as the energy beam, a first direction is the x-axis direction shown in FIGS. 1 and 2, and a second direction is the y-axis direction shown in FIGS. 1 and 2.

In addition, in the present embodiment, a laser scanning along the x-axis direction will be referred to as “x-scan”, and a laser scanning along the y-axis direction will be referred to as “y-scan”.

As shown in FIG. 1, a manufacturing apparatus for a layered structure (hereinafter simply referred to as “manufacturing apparatus”) 1 includes a chamber 2, a powder bed 3, an irradiation section 4, a gas flow generation section 5, a modeling stage 6, and a control section (not shown in figures).

The chamber 2 is a housing in which a layered structure is formed. A shielding gas supply pipe 15 is connected to the upper side of the chamber 2. The shielding gas supply pipe 15 introduces a shielding gas into the chamber 2.

The shielding gas is a gas supplied into the chamber 2 during laser irradiation. As the shielding gas, an inert gas is preferable, and argon gas is more preferable. Depending on the type of raw material powder, a gas other than an inert gas such as oxygen or hydrogen that reacts with the raw material may be used as the shielding gas. When a gas other than an inert gas is used as the shielding gas, the raw material powder and the shielding gas may react with each other, which may provide new properties to the layered structure.

The raw material powder is not particularly limited. Examples of the raw material powder include powders of various metals such as magnesium, calcium, chromium, copper, iron, manganese, molybdenum, cobalt, nickel, hafnium, niobium, titanium, and aluminum, and alloys thereof. Examples of the ceramic powder include powders of silicides, oxides, nitrides, carbides, and borides of the metals above. A mixed powder of powders of the metals, alloys, and their silicides, oxides, nitrides, carbides, and borides above and ceramic powder may be used as the raw material powder.

The particle size of the raw material powder is not particularly limited, and may be, for example, about 10 to 200 μm.

The modeling stage 6 is provided in the chamber 2. The modeling stage 6 has a powder bed 3, a storage section 7, a recovery section 8, and a recoater 9. The recoater 9 reciprocates along the x-axis direction shown in the figures.

The storage section 7 has raw material powder M to be supplied to the powder bed 3, and a first lifting table 11 on which the raw material powder M is placed. As the first lifting table 11 rises, the raw material powder M is deposited above the upper surface of the modeling stage 6. The deposited raw material powder is moved along the x-axis direction by the recoater 9 and supplied to the powder bed 3. The surface of the raw material powder M on the powder bed 3 (the surface of the powder bed) is smoothed flat by the recoater 9.

The recoater 9 and the first lifting platform 11 are electrically connected to the control section (not shown in figures), so that the recoater 9 and the first lifting platform 11 can supply the raw material powder M in the storage section 7 to the powder bed 3 according to instructions from the control section.

The powder bed 3 has raw material powder M, a second lift table 12 on which the raw material powder M is placed, and a base plate (not shown in figures) placed on the surface of the second lift table 12. The second lift table 12 is movable along the z-axis direction. Therefore, the powder bed 3 of the raw material powder M is movable up and down, that is, in the z-axis direction, within the chamber 2.

In the manufacturing apparatus 1, when the second lift table 12 descends by Δh in the z-axis direction, the raw material powder M from the storage section 7 is moved by the recoater 9, and a powder layer of the raw material powder M having a thickness Δh is formed on the powder bed 3. This descending distance Δh of the second lift table 12 in the z-axis direction corresponds to the accumulation thickness Δh of the powder bed for each melt-solidified layer of the layered structure.

The second lift platform 12 is electrically connected to the control section (not shown in figures), so that the second lift platform 12 can control the accumulation thickness Δh of the powder bed 3 according to instructions from the control section.

The irradiation section 4 has a laser oscillator 13 and an optical system 14. The laser oscillator 13 is not particularly limited as long as it is a laser irradiation source.

The optical system 14 reflects the laser from the laser oscillator 13 and irradiates the laser while scanning the raw material powder M on the powder bed 3. The optical system 14 is composed of one or more reflecting mirrors. In addition, both the laser oscillator 13 and the optical system 14 are electrically connected to the control section (not shown in figures).

The irradiation section 4 controls the reflection direction of the laser by the optical system 14 according to an instruction from the control section (not shown in figures). The irradiation section 4 controls the reflection direction of the laser by the optical system 14 and irradiates the laser by scanning.

The irradiation section 4 irradiates the raw material powder M on the powder bed 3 with a laser to sinter or melt and solidify the raw material powder M at the irradiated position, so that a melt-solidified layer of the sintered raw material powder or a melt-solidified layer of the melted and solidified raw material powder can be formed on the powder bed 3.

The gas flow generating section 5 is electrically connected to a control unit (not shown in figures). The gas flow generation section 5 forms a gas flow F along the surface of the powder bed 3 in the vicinity of the surface. Therefore, in addition to controlling the crystallographic texture, the gas flow generation section 5 can also remove spatters, fumes, and the like, which are generated when the melt-solidified layer is irradiated with a laser, by using the gas flow F.

The control section is electrically connected to the laser oscillator 13 and the optical system 14. Therefore, the gas flow generation section 5 can change the gas flow direction F with respect to the scanning direction of the energy beam (laser) irradiated to form a melt-solidified layer whose crystallographic texture is to be controlled. The gas flow generation section 5 can also adjust the flow rate of the gas flow F according to instructions from the control section (not shown in figures).

The flow rate of the gas flow F on the surface of the powder bed 3 is preferably 0.1 to 10 m/s, and more preferably 1.0 to 5.0 m/s.

The composition of the gas flow F is preferably the same as that of the shielding gas. For example, the gas flow F may include a gas containing at least one selected from the group consisting of helium, nitrogen, neon, argon, and xenon. The gas flow F may contain one of these gas components alone or two or more of them in combination.

The gas flow direction F can be changed by changing the position and orientation of the gas flow generation section 5 relative to the modeling stage 6.

Depending on the type of the raw material powder M, when a gas other than an inert gas such as oxygen or hydrogen that reacts with the raw material is used as the shielding gas, it is also possible to use a gas other than an inert gas such as oxygen or hydrogen as a gas flow. In this case, the raw material powder may react with the gas flow, which may provide new properties to the layered structure.

The control section (not shown in figures) may include, for example, a central processing unit (CPU), a memory, and a hard disk drive. The hard disk drive may include a CAD application and a CAM (Computer-Aided Manufacturing) application. In this case, the control section can create three-dimensional structural data of a layered structure of a desired shape.

The control section (not shown in figures) creates processing condition data based on the three-dimensional structure data. The processing condition data can be created for each melt-solidified layer. The control section (not shown in figures) controls the irradiation section 4 (laser oscillator 13 and optical system 14) based on the processing condition data, and can adjust the laser power, scanning speed, hatch distance, and irradiation position.

The recovery section 8 has a third lifting platform 16. The third lifting platform 16 is movable along the z-axis direction. In the manufacturing apparatus 1, when the powder bed 3 is formed by the recoater 9, excess raw material powder can be recovered in the recovery section 8. In addition, when recovering the layered structure after modeling is completed, the raw material powder remaining on the modeling stage 6 can be moved to the recovery section 8 by the recoater 9 and recovered.

### (Manufacturing Method for Layered Structure)

Next, the manufacturing method for a layered structure as one embodiment of the present invention will be explained.

The manufacturing method for a layered structure of the present embodiment is a manufacturing method for a layered structure including at least one x-scan layer and including crystallographic texture in which at least one y-scan layer and the at least one x-scan layer and the at least one y-scan are layered in a thickness direction, including the steps of: providing a gas flow parallel to the surface of a powder bed on which raw material powder is deposited; forming the x-scan layer (first melt-solidified layer) by irradiating while scanning (x-scan) an energy beam in an x direction (first direction) which is parallel to the surface of the powder bed; and forming the y-scan layer (second melt-solidified layer) by irradiating while scanning (y-scan) an energy beam in a y direction (second direction) which is parallel to the surface of the powder bed and intersects the x direction;
wherein a residual thickness of the x-scan layer and a residual thickness of the y-scan layer in the crystallographic texture are controlled by the steps of:
when forming the x-scan layer, adjusting an accumulation thickness (first accumulation thickness) of the powder bed and a heat input amount (first heat input amount) of the energy beam irradiated to the powder bed to control a layer thickness and a penetration depth of the x-scan layer; and
when forming the second melt-solidified layer, adjusting an accumulation thickness (second accumulation thickness) of the powder bed and a heat input amount (second heat input amount) of the energy beam irradiated to the powder bed to control a layer thickness and a penetration depth of the y-scan; and
wherein the heat input amount in the x-scan is controlled by adjusting a smallest angle αx (α1) between the x-axis direction and the gas flow direction F, and the heat input amount in the y-scan is controlled by adjusting a smallest angle αy (α2) between the y-axis direction and the gas flow direction F.

Hereinafter, the manufacturing method for a layered structure of the present embodiment will be specifically described with reference to the drawings, assuming that the above-mentioned manufacturing apparatus 1 is used.

In the manufacturing method for a layered structure of the present embodiment, a layered structure is obtained by layering multiple melt-solidified layers formed by irradiating a laser as an energy beam onto a powder bed of raw material powder. Based on the CAD data of the layered structure, the formation of the powder bed, the formation of the melt-solidified layer, and the layering of the melt-solidified layers are repeated any number of times.

When the manufacturing apparatus shown in FIGS. 1 and 2 is used, a first layer formed by the first irradiated laser, that is, the bottom melt-solidified layer, comes into contact with a base plate (not shown in figures) on the surface of the second lift table 12. After that, each melt-solidified layer is sequentially layered on top of the first melt-solidified layer.

Before the laser irradiation, it is preferable to supply the shield gas from the shield gas supply pipe 15 into the chamber 2 and into the cavities below the first lifting platform 11, the second lifting platform 12, and the third lifting platform 16. This fills the entire chamber 2 with the shield gas. Therefore, in the presence of a sufficient amount of the shield gas, heat can be supplied to the raw material powder using a laser to form the melt-solidified layer. When an inert gas is used as the shield gas, if the chamber 2 is not filled with shield gas, the raw material powder reacts with gases other than the shield gas, making it difficult to obtain the desired layered structure characteristics. When a gas other than an inert gas such as oxygen or hydrogen that reacts with the raw material is used as the shield gas, if the chamber 2 is not filled with the shield gas, the raw material powder and the shield gas do not react sufficiently, making it difficult to obtain a metal texture that can impart new characteristics to the layered structure.

In the present embodiment, by using the irradiation section 4, the x-scan and the y-scan are repeatedly and alternately performed to layer a plurality of melt-solidified layers in the z-axis direction.

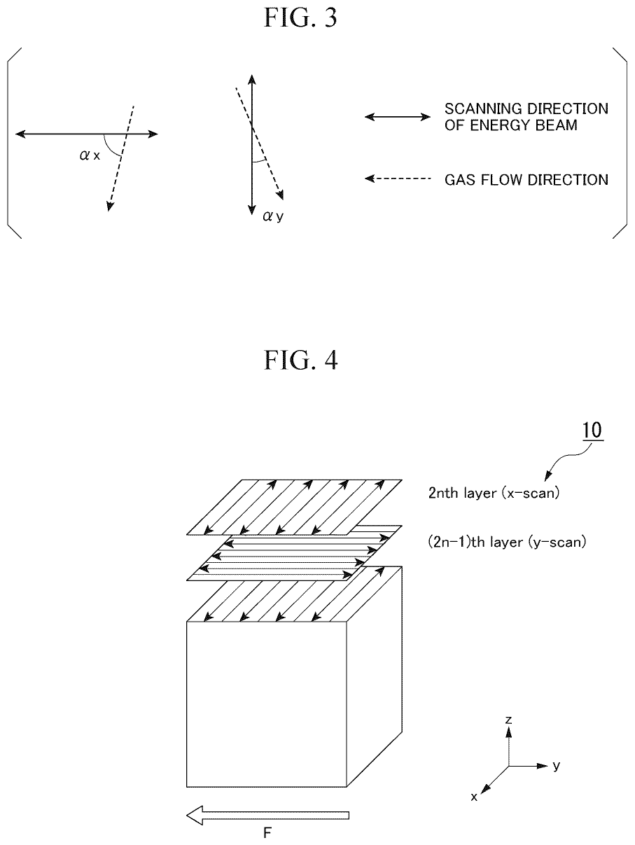

At this time, the gas flow direction F of the shielding gas differs between the x-scan and the y-scan, as shown in FIG. 3. Specifically, when a smallest angle between the scanning direction of the energy beam and the gas flow direction F in the x-scan is αx, and a smallest angle between the scanning direction of the energy beam and the gas flow direction F in the y-scan is αy, the gas flow direction of the shielding gas is changed according to the scanning direction of the laser so that the relationship αx>αy is satisfied.

For example, as shown in FIG. 4, a (2n−1)th melt-solidified layer can be formed by y-scanning, and a 2nth melt-solidified layer can be formed by x-scanning (n: natural number) to produce a layered structure 10. In this case, the (2n−1)th melt-solidified layer is a melt-solidified layer formed by y-scanning (hereinafter, may be referred to as a “y-scan layer”), and the 2nth melt-solidified layer is a melt-solidified layer formed by x-scanning (hereinafter, may be referred to as an “x-scan layer”).

In forming the (2n−1)th powder bed, the raw material powder from the storage section 7 is supplied to the surface of second lift table 12 by the recoater 9, and a powder bed of accumulation thickness Δh is formed on the upper side of the (2n−2)th melt-solidified layer. A laser is irradiated onto the powder bed of an accumulation thickness Δh to form the (2n−1)th melt-solidified layer. In forming the (2n−1)th melt-solidified layer, the powder layer is sintered or melt-solidified by laser scanning. As a result, the (2n−1)th melt-solidified layer is layered on the upper side of the (2n−2)th melt-solidified layer.

In forming the 2nth powder bed, a powder bed with an accumulation thickness Δh is formed on the upper side of the (2n−1)th melt-solidified layer. Then, a laser is irradiated onto the upper side of the powder bed formed on the surface of the (2n−1)th melt-solidified layer. Then, the powder layer is sintered or melt-solidified by laser scanning, forming the 2nth melt-solidified layer, and the 2nth melt-solidified layer is layered on the upper side of the (2n−1)th melt-solidified layer.

In this way, by repeating the formation of the powder bed, the formation of the melt-solidified layer, and the layering, a layered structure can be manufactured by layering multiple melt-solidified layers. By repeatedly performing x-scan and y-scan alternately, the layered structure 10 can be manufactured that has a crystallographic texture in which the x-scan layer and the y-scan layer are repeatedly layered. The layered structure 10 is removed from the chamber 2 while placed on a base plate.

A method for manufacturing the layered structure 10 in which the crystallographic textures of the x-scan layer and the y-scan layer are controlled will be described below.

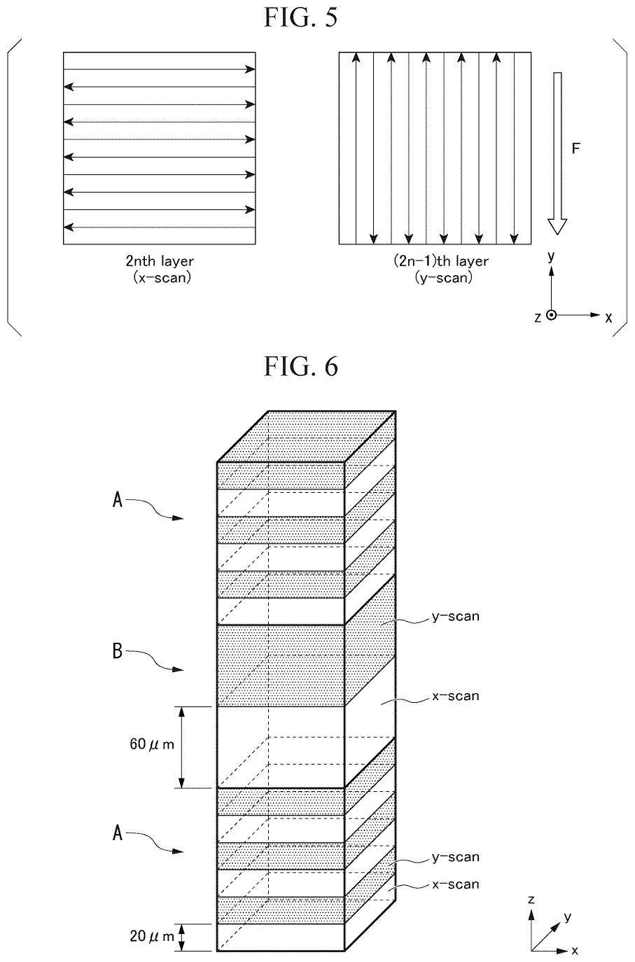

FIG. 5 shows a case where the gas flow direction F is perpendicular to the x-scan direction and parallel to the y-scan direction. In this case, αx is 90° and αy is 0°.

At this time, if the laser power and the scanning speed are constant, the laser is affected by the gas flow F, and the amount of heat input to the powder bed by the laser during y-scan is attenuated more than the amount of heat input to the powder bed by the laser during x-scan. As a result, the penetration depth of the melt-solidified layer in y-scan is smaller than that in x-scan, and the thickness of the y-scan layer is smaller than the thickness of the x-scan layer in the crystallographic texture.

In this way, in the manufacturing method for a layered structure of the present embodiment, when the x-scan and the y-scan are repeatedly and alternately performed, the penetration depth of the y-scan layer to be controlled in the crystallographic texture becomes smaller than the penetration depth of the x-scan layer by changing the gas flow direction F so as to satisfy the relationship αx>αy. As a result, the residual thickness of the y-scan layer can be changed in the crystallographic texture contained in the layered structure.

According to the manufacturing method for a layered structure of the present embodiment, the crystal orientation of the crystallographic texture and the orientation of the crystal direction can be adjusted by intentionally changing the gas flow direction F, so that the crystallographic texture of the layered structure can be easily controlled. In this case, by changing the flow rate of the gas flow F in addition to changing the gas flow direction F, the crystallographic texture of the layered structure can be changed more precisely.

When the y-scan layer is the target for controlling the crystallographic texture, it is also effective to change the accumulation thickness of the powder bed for the y-scan layer from the accumulation thickness of the powder bed for forming the adjacent x-scan layer.

By varying the accumulation thickness of the powder bed for the y-scan layer and the accumulation thickness of the powder bed for the x-scan layer, the residual thickness of the y-scan layer can be precisely changed in the crystallographic texture in the layered structure.

As a result, the crystal orientation of the crystallographic texture and orientation of the crystal direction can be adjusted by changing the accumulation thickness of the powder bed, making it easy to control the crystallographic texture of the layered structure.

For example, by making the accumulation thickness of the x-scan layer and the accumulation thickness of the y-scan layer the same and making these accumulation thicknesses larger than the difference “Sx−Sy” between the penetration depth “Sx” of the melt-solidified layer in the x-scan and the penetration depth “Sy” of the melt-solidified layer in the y-scan, the y-scan layer can be intentionally left in the layered structure.

Furthermore, by making the accumulation thickness of the x-scan layer and the accumulation thickness of the y-scan layer the same and making these accumulation thicknesses smaller than the difference “Sx−Sy” between the penetration depth “Sx” of the melt-solidified layer in the x-scan and the penetration depth “Sy” of the melt-solidified layer in the y-scan, the y-scan layer can be overwritten and erased with the x-scan layer.

The penetration depth of the melt-solidified layer in the x-scan “Sx” and the penetration depth of the melt-solidified layer in the y-scan “Sy” can be determined by observing the metal structure of the molded product as shown below.

### [Measuring Method for Penetration Depth (Melt Depth or Melt Pool Depth) of Melt-Solidified Layer]

The metal structure is mirror-finished by polishing with sandpaper and buffing, then etched and observed under a microscope for measurement. The scanning direction of the laser (energy beam) on the observed metal texture can be determined from the overlapping direction of the molten pool. In the case of the x-scan, when x-scan laser irradiation is repeated toward the +y direction, molten pool superscription in the +y direction can be seen in the yz plane, and the molten pools overlap toward the +y direction. In the case of the y-scan, when y-scan laser irradiation is repeated toward the −x direction, molten pool superscription in the −x direction can be seen in the xz plane, and the molten pools overlap toward the −x direction.

In this way, in each layer constituting the layered structure, the crystal orientation of the crystallographic texture and crystal direction can be further changed, providing greater precision in controlling the crystallographic texture.

In addition, by changing the accumulation thickness Δh of the powder bed, it is possible to provide different crystallographic textures within one layered structure and impart anisotropy to the mechanical properties.

For example, as shown in FIG. 6, a layered structure in which the crystallographic texture changes in the Z direction can be manufactured by repeatedly performing additive manufacturing with a layer thickness Δh of 20 μm to form crystallographic texture A, and then repeatedly performing additive manufacturing with a layer thickness Δh of 60 μm to form a crystallographic texture B.

Furthermore, the crystallographic texture can be controlled not only in the layering direction (Z direction) but also within the XY plane of the melt-solidified layer. For example, if a melt-solidified layer is formed by irradiating a laser at an arbitrary location while the accumulation thickness Δh of the powder bed is small, and a powder bed is then provided on top of the melt-solidified layer, the residual thickness can be locally increased by irradiating the laser to the powder bed on the unirradiated part in the melt-solidified layer with laser. In this way, the crystallographic texture can be controlled within the plane of the melt-solidified layer.

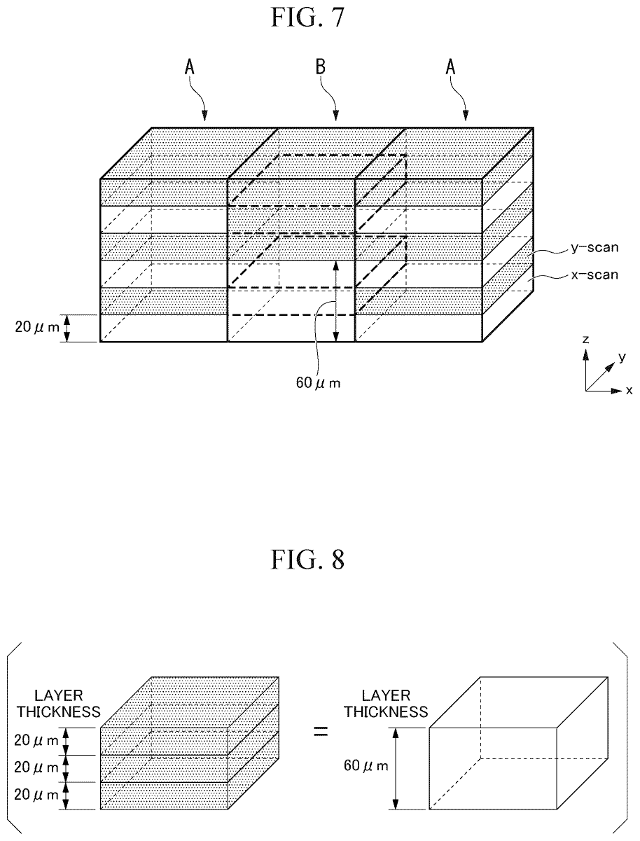

For example, as shown in FIG. 7, in additive manufacturing with a layer thickness Δh of 20 μm, a laser may be irradiated each time a layer is layered in the left and right modeling regions in FIG. 7 to form a crystallographic texture A, while in the central modeling region in FIG. 7, a laser may not be irradiated in the first and second layering steps, but a laser may be irradiated in the third layering step to form a crystallographic texture B with a layer thickness Δh of 60 μm.

As explained above, according to the manufacturing method for a layered structure of the present embodiment, the crystallographic texture contained in the layered structure of any three-dimensional structure can be easily controlled, and any crystal orientation can be controlled. Such a layered structure has an advantageous effect on various products covering a wide range of industrial fields. For example, advantages such as obtaining a crystallographic texture that exhibits desired mechanical properties and satisfying various requirements for properties of the layered structure can be achieved.

For example, when the accumulation thickness Δh of the powder bed is reduced, the y-scan layer tends to disappear from the layered structure. Therefore, even if x-scan and y-scan are performed alternately, the y-scan layer can be intentionally erased from the layered structure, and a layered structure having the same crystallographic texture as that obtained by performing only x-scan can be manufactured.

In contrast, when the accumulation thickness Δh of the powder bed is increased, the y-scan layer tends to remain in the layered structure, and therefore a crystallographic texture in which the x-scan layer and the y-scan layer are mixed tends to appear.

For example, in a layered structure of stainless steel, when the y-scan layer is layered as the (2n−1)th layer and the x-scan layer is layered as the 2nth layer alternately with a layer thickness of a predetermined thickness or more, a <001> single crystalline-like texture appears along the layering direction, that is, the z-axis direction.

On the other hand, in a layered structure of stainless steel, when the y-scan layer is layered as the (2n−1)th layer and the x-scan layer is layered as the 2nth layer alternately at a layer thickness less than a predetermined thickness, a crystallographic lamellar texture consisting of two types of <001> and <011> appears along the layering direction, that is, the z-axis direction.

In the present embodiment, the accumulation thickness Δh of the powder bed for each melt-solidified layer of the layered structure is changed by changing the descending distance Δh in the z-axis direction of the second lift table 12. In addition, after a powder bed with an accumulation thickness Δh is formed on the upper side of the melt-solidified layer, the powder bed may be formed again without irradiating the powder bed with a laser, thereby changing the accumulation thickness Δh of the powder bed. For example, as shown in FIG. 8, for a layer thickness Δh of 20 μm, the layer thickness Δh may be set to 60 μm by not irradiating the powder bed with a laser in the first and second layering steps and irradiating the laser in the third layering step.

### OTHER EMBODIMENTS

Although one embodiment has been described above, the present invention is not limited to the contents of the disclosure above and can be modified as appropriate without changing the gist of the invention. The disclosed embodiments can be implemented in various other forms, and various omissions, substitutions, and modifications can be made without departing from the gist of the invention.

For example, in the above-described embodiment, the melt-solidified layer to be controlled in the crystallographic texture may be multiple melt-solidified layers, or may be a single melt-solidified layer. When multiple melt-solidified layers are to be controlled, multiple melt-solidified layers may all be formed with an energy beam having the same scanning direction, or may be formed with energy beams having mutually different scanning directions.

Furthermore, in the above-described embodiment, a case where the laser scanning direction is two directions, the x direction and the y direction, has been described as an example, but the present invention is not limited to the above-described embodiment. The laser scanning direction may be three or more directions.

Specifically, when the laser scanning direction is three directions, the smallest angle between the first direction and the second direction, the smallest angle between the second direction and the third direction, and the smallest angle between the third direction and the first direction may each be 60°.

In addition, when the laser scanning direction is four directions, the smallest angle among the angles between the first direction and the second direction, the smallest angle among the angles between the second direction and the third direction, the smallest angle among the angles between the third direction and the fourth direction, and the smallest angle among the angles between the fourth direction and the first direction may each be 45°.

Furthermore, when the first to fifth melt-solidified layers are designated A, B, C, D, and E, the present invention includes the following embodiments (1) to (5).
(1) A method of layering layers A and B alternately over the entire layered structure
   Lowest layer side: ABABABAB . . . ABABABAB: Top layer side
(2) A method of layering layers A to E repeatedly over the entire layered structure
   Lowest layer side: ABCDE . . . ABCDE: Top layer side
(3) A method of layering layers A, B, and C repeatedly over the entire layered structure
   Lowest layer side: ABCABCABC . . . ABCABCABC: Top layer side
(4) A method of layering consecutive layers A and consecutive layers B alternately over the entire layered structure
   Lowest layer side: AAABBBAAAA . . . BBBAAABBB: Top layer side
(5) A method of layering consecutive layers A, consecutive layers B, and consecutive layers C alternately over the entire layered structure.
   Bottom layer: AABBCC . . . AABBCC: Top layer

In the above embodiments, the case where the gas flow direction F is perpendicular to the x-scan direction and parallel to the y-scan direction (that is, αx=90°, αy=0°) has been described as an example, but the present invention is not limited to this embodiment. For example, αx may be 45° or more and 90° or less, and αy may be 0° or more and 45° or less.

For example, in the above-described embodiment in which the (2n−1)th melt-solidified layer is formed by y-scanning and the 2nth melt-solidified layer is formed by x-scanning to manufacture the layered structure 10, modifications can be made to adopt the following operations (α) and (β).
Operation (α): When forming the (2n−1)th y-scan layer, the gas flow direction F is changed so that αy is between 0° and 45°.
Operation (β): When forming the 2nth x-scan layer, the gas flow direction F is changed so that αx is between 45° and 90°.

It is considered that the residual thickness of the x-scan layer and the y-scan layer in the crystallographic texture included in the layered structure can be changed by the operations (α) and (β). In addition, further variations can be provided in the aspect of controlling the crystallographic texture of the layered structure.

The operations (α) and (β) can be used in combination when manufacturing one layered structure. When the operations (α) and (β) are carried out, it is thought that the effects of each operation are obtained in a superimposed manner. In this case, the operations (α) and (β) may be carried out continuously to form the x-scan layers and the y-scan layers that are adjacent to each other; the operations (α) and (β) may be used intermittently to form the x-scan layers and the y-scan layers that are not adjacent to each other and are separated by multiple melt-solidified layers.

Although not shown in the figures, in another embodiment, the (2n−1)th layer may be formed by scanning the laser along the x-axis direction, and the 2nth layer may be formed by scanning the laser along the y-axis direction. In this case, the (2n−1)th layer is the x-scan layer, and the 2nth layer is the y-scan layer.

In each of the x-scan and the y-scan, the scanning mode may be either back and forth or in one direction.

In the above-described embodiments, although the scanning direction of the laser is fixed and the gas flow direction F is changed, the present invention is not limited to the embodiments above. For example, the gas flow direction F may be fixed and the scanning direction of the laser may be changed. By fixing the gas flow direction F and changing the scanning direction of the laser, it is possible to control the crystallographic texture of the layered structure with respect to the gas flow F.

When considering more flexible control of the crystallographic texture of the layered structure, it is preferable to fix the scanning direction of the laser and change the gas flow direction F, as described in the embodiments above.

### Examples

The effects of the present invention will be described below with reference to experimental examples, but the present invention is not limited to the following description in any way.

### <Experimental Example>

A raw powder with the following composition was prepared using a gas atomization method.

Composition: 18Cr-14Ni-2.5Mo-0.03C-65.47Fe (% by mass) The particle size of the obtained raw powder was 53 μm or less.

The manufacturing conditions for the layered structure were as follows:
Apparatus used: EOS M290 (manufactured by EOS)
Laser scanning: X-scan and y-scan were performed alternately. The laser scanning was performed back and forth in each of the x-scan and y-scan (see FIGS. 4 and 5)
Layer thickness: 20 μm or 60 μm
Power: 250 W
Scanning speed of x-scan and y-scan: 800 mm/s
Hatch distance of x-scan and y-scan: 0.08 mm

The gas flow conditions of the gas flow generating unit 5 were as follows.
Gas type: Argon gas
Gas flow direction: Argon gas was flowed along the y-axis when y-scan was performed. The y-scan layer was the melt-solidified layer to be controlled.
Gas flow rate: The flow rate on the surface of the powder bed 3 in the modeling stage 6 was measured using a vane-type anemometer Testo 440 dP (manufactured by Testo) (see FIG. 2). Measurements were taken at three points P1, P2, and P3 on a plane that passed through the center of the powder bed 3 in the x-axis direction and along the y-axis direction.
P1: A position at the center of the powder bed 3 in the x-axis direction, approximately 90 mm from the gas flow generating section 5 in the y-axis direction, and approximately 8 mm away from the surface of the powder bed 3 in the z-axis direction
P2: A position at the center of the powder bed 3 in the x-axis direction, approximately 135 mm from gas flow generation section 5 in the y-axis direction, and approximately 8 mm from the surface of the powder bed 3 in the z-axis direction
P3: A position at the center of the powder bed 3 in the x-axis direction, approximately 180 mm from gas flow generation section 5 in the y-axis direction, and approximately 8 mm in the z-axis direction from the surface of the powder bed 3

The gas flow velocity at P1 was 1.9 m/s.

The gas flow velocity at P2 was 1.7 m/s.

The gas flow velocity at P3 was 1.7 m/s.

The evaluation method for the crystallographic texture of the layered structure was as follows.

### [Evaluation Method for Crystallographic Texture of Layered Structure]

A scanning electron microscope (FE-SEM) and electron backscattered diffraction (EBSD) were used. The layered structure was cut in the xz and yz planes, polished with emery paper up to #4000, and polished to a mirror finish using colloidal silica. Etching was then performed using an etching solution containing 21% HF, 29% HNO₃, and 50% H₂O. The crystal directions of the xz and yz cross sections were then observed and analyzed.

JIB-4610F (manufactured by JEOL) was used as the FE-SEM.

NordlysMax3 (manufactured by Oxford Instruments) was used as the EBSD.

### <Experimental Example 1>

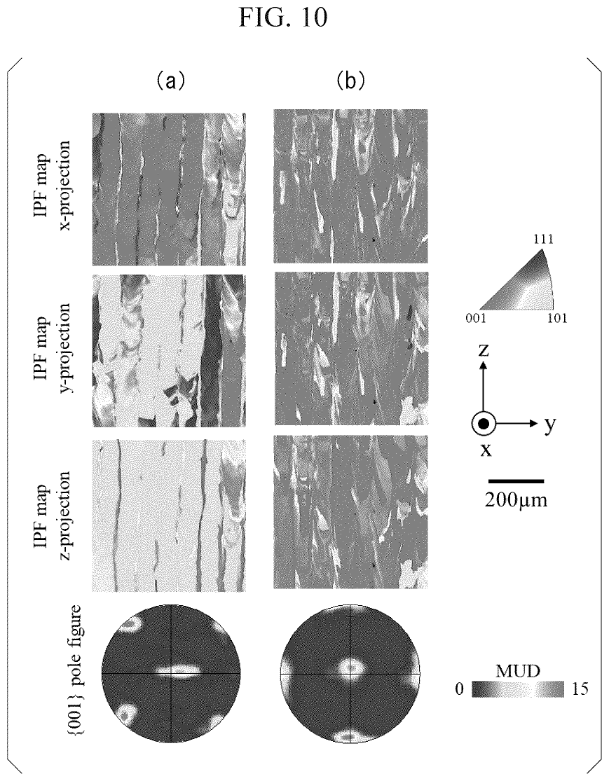

Under the conditions above, a layered structure with a layer thickness of 20 μm was produced. FIG. 10 shows the crystal direction map and pole figures. As shown in FIG. 10(a), a unique lamellar texture was confirmed in which the <011> crystal direction appeared along the z axis (layering direction) and the <001> appeared at equal intervals.

### <Experimental Example 2>

Under the conditions above, a layered structure with a layer thickness of 60 μm was produced. FIG. 10 shows the crystal direction map and pole figure. As shown in FIG. 10(b), a single crystalline-like texture of <001> was confirmed along the z axis (layering direction).

### <Crystallographic Texture of Layered Structure in Experimental Examples 1 and 2>

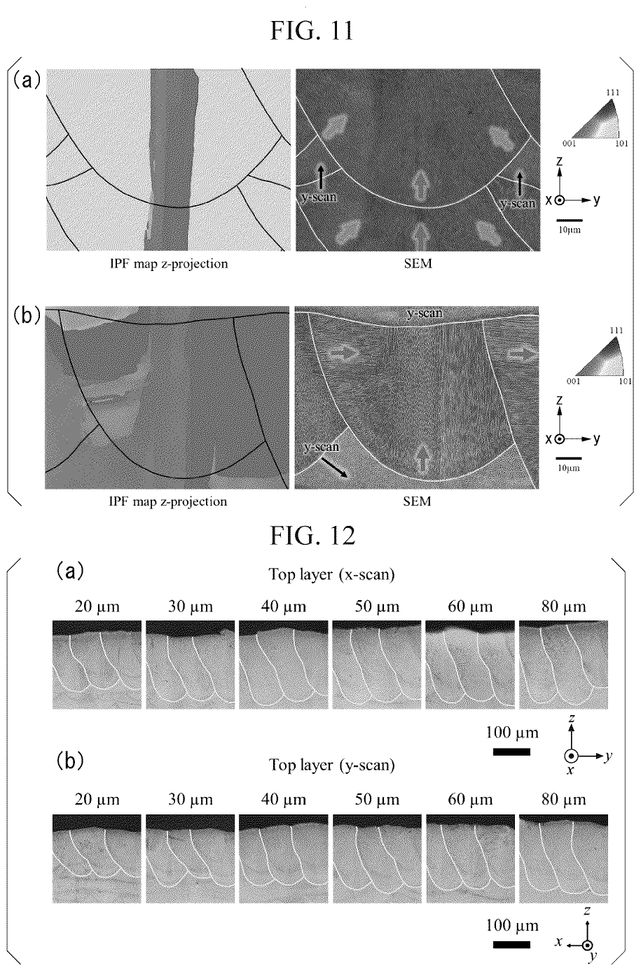

FIG. 11 shows the results of observing the crystallographic texture of the layered structure produced in Experimental Examples 1 and 2. The arrows in FIG. 11 indicate the temperature gradient that accompanies melting. In general, the cellular texture (solidified texture) is said to grow in a direction close to this temperature gradient, and the extension direction of this cellular texture is parallel to the <100> direction.

As shown in the upper part of FIG. 11(a), in the experimental example 1 obtained with a layer thickness of 20 μm, as shown by the arrows on the yz plane, by the x-scan, the cellular texture grows along two directions (±45°) from the construction direction of the melt pool, and the <100> is oriented in that direction, which corresponds to the <011> direction in the crystal direction map. In addition, in the center of the melt pool, the cellular texture grows along the layering direction, which corresponds to the <001> direction.

On the other hand, it was confirmed that in the y-scan layer, the crystal orientation due to the x-scan was dominant. The reason for the result was thought to be because the layer formed by the y-scan was reduced compared to the layer formed by the x-scan, causing the y-scan to be overwritten by the x-scan, resulting in a crystal orientation biased towards the x-scan.

In Experimental Example 1, it was thought that the y-scan layer was overwritten by the x-scan, causing the layer thickness of the y-scan layer to decrease or disappear. As a result, it was speculated that a crystallographic lamellar texture appeared in the layered structure.

As shown in the lower part of FIG. 11(b), in Experimental Example 2, which was produced with a layer thickness of 60 μm, a long and narrow cellular texture grew from the bottom of the melt pool along the layering direction, and grew from the upper wall of the melt pool in a direction perpendicular to the molding direction. As a result, a <001> single crystalline-like texture was formed in the layered structure along the molding direction.

In Experimental Example 2, the layer thickness was sufficiently larger than in Experimental Example 1, so it was presumed that y-scan remained and a single crystalline-like texture appeared, rather than a crystallographic lamellar texture.

### <Experimental Example 3>

The layer thickness was changed to 20 μm, 30 μm, 40 μm, 50 μm, 60 μm, and 80 μm, and the melt depth of the x-scan layer and the melt depth of the y-scan layer were measured using the polishing and etching conditions described above in the [Evaluation method for crystallographic texture of layered structure] and the [Measuring method for penetration depth (melt depth or melt pool depth) of melt-solidified layer].

Specifically, the layered structure was cut, polished, and etched under the same conditions as those described above in [Evaluation method for crystallographic texture of layered structure], and the crystal directions of the xz and yz cross sections were observed and measured. The melting depth of the x-scan layer was measured by forming a layered structure so that the last layer (top layer) ended with an x-scan, and observing the yz surface. The melting depth of the y-scan layer was measured by forming a layered structure so that the last layer (top layer) ended with a y-scan, and observing the xz surface.

The conditions for producing the layered structure were the same as those for Experimental Examples 1 and 2, except that the layer thickness was changed as described above.

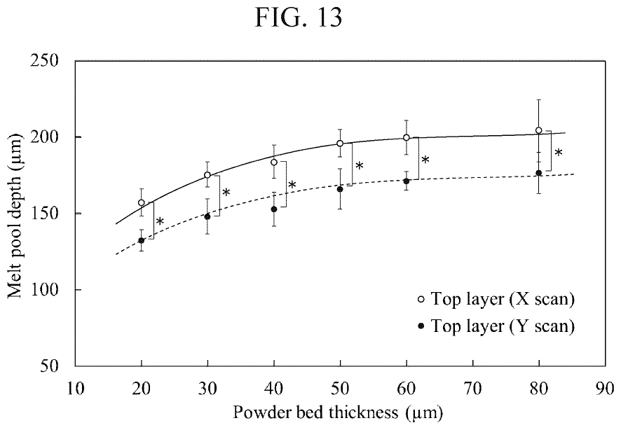

FIG. 12 shows the results of observing the crystallographic texture of the layered structure produced in Experimental Example 3. FIG. 13 shows the relationship between the accumulation thickness of the powder bed and the depth of the molten pool in Experimental Example 3. The depth of the molten pool was measured by the [Measuring method for penetration depth (melt depth or melt pool depth) of melt-solidified layer] described above.

As shown in FIGS. 12 and 13, in the y-scan, the energy was attenuated more than in the laser scanning perpendicular to the gas flow (x-scan), and as a result, the melt depth of the y-scan layer was smaller than the melt depth of the x-scan layer. The difference “Sx−Sy” between the melt depth “Sx” in the x-scan and the melt depth “Sy” in the y-scan is shown in Table 1 below. As shown in Table 1, the average value of “Sx−Sy” was 28.5 μm.

TABLE 1

| Layer | | | |
|---|---|---|---|
| thickness | Sx | Sy | Sx − Sy |
| [μm] | [μm] | [μm] | [μm] |
| 20 | 157 | 132 | 25 |
| 30 | 175 | 148 | 28 |
| 40 | 184 | 153 | 31 |
| 50 | 196 | 166 | 30 |
| 60 | 200 | 171 | 29 |
| 80 | 204 | 176 | 28 |

The asterisk “*” in FIG. 13 indicates that the P value obtained by statistical analysis using the “Student's t-test” shown below was less than 0.05. When the P value was less than 0.05, it indicated that the difference in the data connected by the line was significant. All of the data differences shown in FIG. 13 have P values less than 0.05, and it was confirmed that they were significant.

The “Student's t-test” included a P-value to determine significant differences and a confidence interval for the population mean difference. The P-value was used to investigate whether the population means of the two populations (two groups) could be said to be equal based on the mean and standard deviation of the two populations. Specifically, 10 melt depths Sx and Sy were measured, and a t-test (two-tailed test) was performed on two samples with equal variances using the “T. TEST” function in “Microsoft Excel for Microsoft 365.”

### <Experimental Example 4>

The residual thickness (x-scan thickness) of the x-scan layer and the residual thickness (y-scan thickness) of the y-scan layer when the layer thickness was changed to 20 μm, 30 μm, 40 μm, 50 μm, 60 μm, and 80 μm were measured using the polishing and etching conditions described in [Evaluation method for crystallographic texture of layered structure] and [Measuring method for penetration depth (melt depth or melt pool depth) of melt-solidified layer] above.

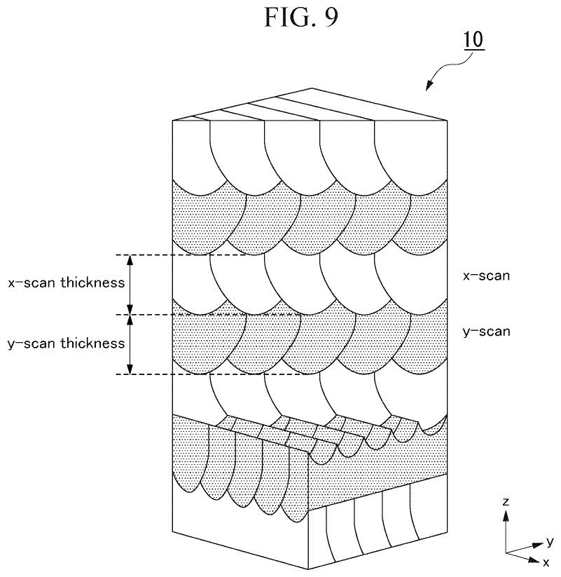

In order to simultaneously and uniformly observe the molten pool (melt pool) generated by laser scanning along the x and y directions, a cross section at 45° to the x and y directions and parallel to the z direction was observed, as shown in FIG. 9.

The conditions for producing the layered structure were the same as those for Experimental Examples 1 and 2, except that the layering thickness was changed as described above.

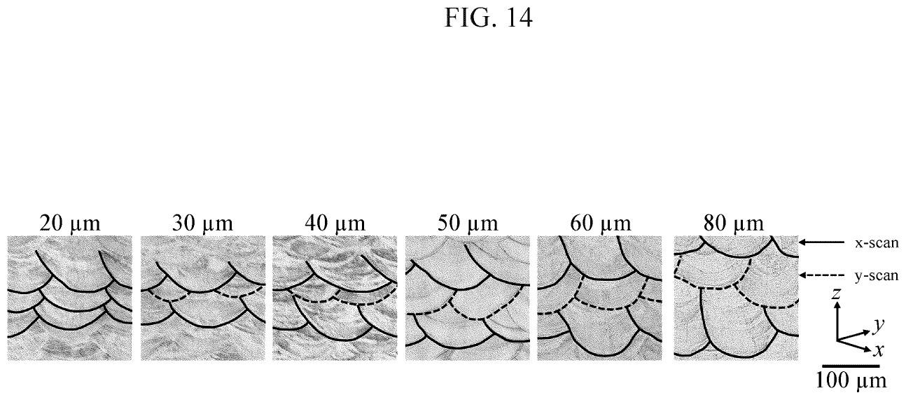

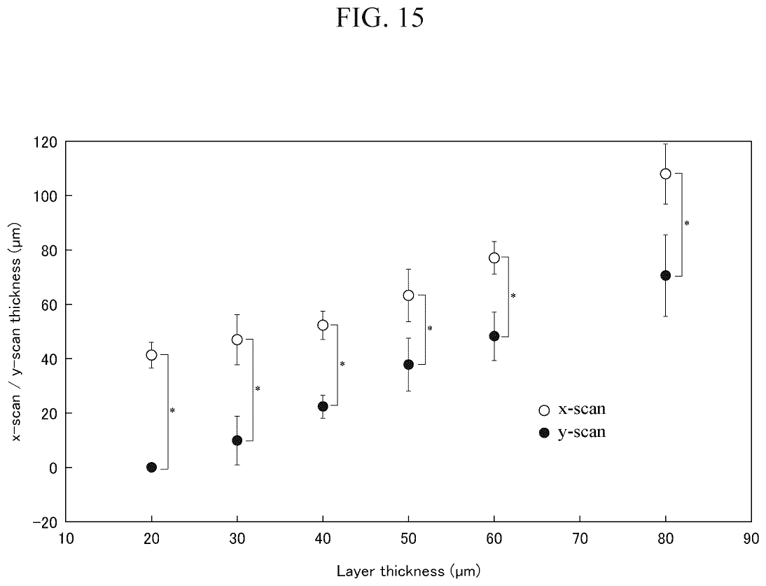

As shown in the results in FIGS. 14 and 15, in the y-scan, energy was attenuated more than in the laser scanning perpendicular to the gas flow (x-scan), and as a result, the thickness of the y-scan layer could be controlled to be smaller than the thickness of the x-scan layer.

Furthermore, the data differences in FIG. 15 all had the above-mentioned “P value” of less than 0.05, confirming that they were significant.

In addition, in the layer thickness of 20 μm, the y-scan was overwritten by the x-scan, and a crystallographic texture with a crystal orientation biased in the x-scan was confirmed. As a result, one type of crystallographic texture that remained along the layering direction appeared in the layered structure.

In the layer thickness of 30 μm, the y-scan was not overwritten by the x-scan, and a crystallographic texture with a crystal orientation biased in each of the x-scan and the y-scan was confirmed. As a result, two types of crystallographic textures that remained along the layering direction appeared in the layered structure.

In the layer thicknesses of 40 μm or more, the y-scan was not overwritten by the x-scan, and a crystallographic texture with a crystal orientation biased in each of the x-scan and the y-scan was confirmed. Furthermore, it was also confirmed that the crystallographic texture by the y-scan was in contact with adjacent molten pools. The number of contact points increased as the layer thickness increased.

### <Experimental Example 5>

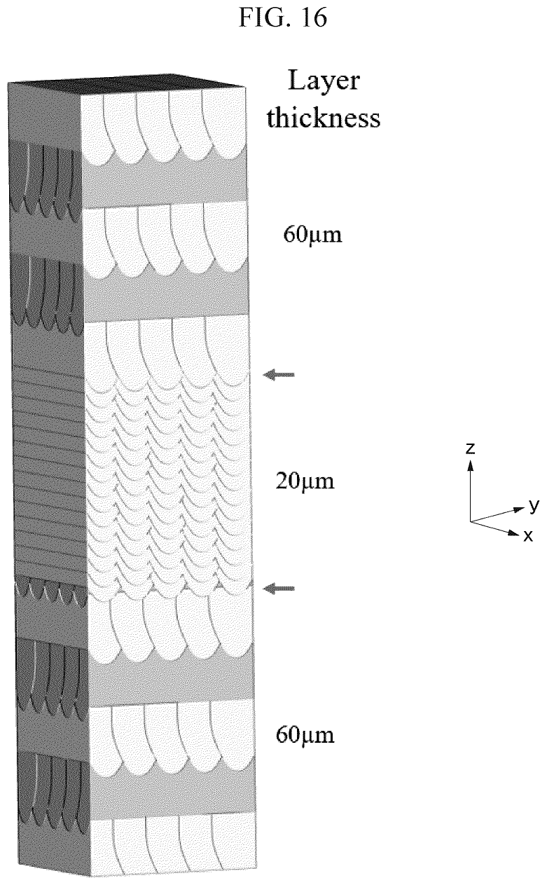

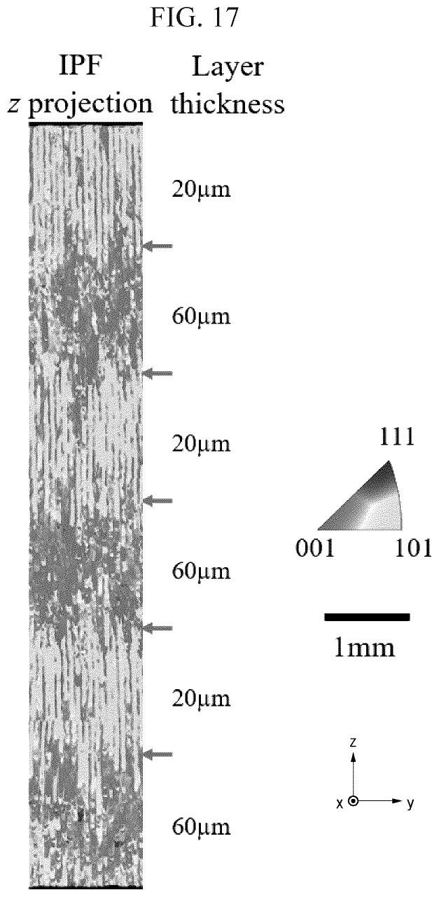

The layer thickness of the powder bed was repeatedly changed from 20 μm to 60 μm to 20 μm. It was thought that the layered structure shown in FIG. 16 would be produced. As shown in FIG. 16, when the layer thickness was 20 μm, the y-scan layer was overwritten by the x-scan layer and disappeared from the layered structure. On the other hand, when the layer thickness was 60 μm, the y-scan layer remained in the layered structure. As a result, a layered structure in which the y-scan layer partially disappeared was obtained. As shown in FIG. 17, two types of crystallographic textures appeared along the layering direction.

From the results of the Experimental Examples above, it was confirmed that by controlling the smallest angle α between the scanning direction of the laser (energy beam) and the gas flow direction F, and by controlling the accumulation thickness of the powder bed, it is possible to form a lamellar texture containing at least <001> and <011> in the layering direction, or a single crystalline-like texture with a <001>. In this way, even if the scanning direction of the laser is fixed to x-y (90°), it is also advantageous to be able to change the crystal orientation in the layering direction by controlling the smallest angle α between the scanning direction of the laser and the gas flow direction F, and by controlling the accumulation thickness of the powder bed. For example, even if the orientation of the parts with respect to the layering direction was changed, parts with any crystal orientation could be obtained, and it is expected that the mechanical strength, elastic modulus, and the like can be widely controlled by controlling the crystal orientation.

In general, any raw material powder can be melted by adjusting the process parameters of the power of the heat source (energy beam), the scan speed, and the scan strategy. The Experimental Examples above are experimental results of a stainless alloy, but if the raw material can be melted by a laser, the same effect as that of a stainless alloy can be obtained.

### EXPLANATION OF SYMBOLS

1 Manufacturing apparatus for a layered structure
2 Chamber
3 Powder bed
4 Irradiation section
5 Gas flow generation section
6 Modeling stage
7 Storage section
8 Recovery section
9 Recoater
10 Layered structure
11 First lifting platform
12 Second lifting platform
13 Laser oscillator
14 Optical system
15 Shielding gas supply pipe
16 Third lifting platform
M Raw material powder

1. A manufacturing method for a layered structure including at least one first melt-solidified layer and at least one second melt-solidified layer, and including crystallographic texture in which the at least one first melt-solidified layer and the at least one second melt-solidified layer are layered in a thickness direction, including the steps of:
providing a gas flow parallel to the surface of a powder bed on which raw material powder is deposited;
forming the first melt-solidified layer by scanning and irradiating an energy beam in a first direction which is parallel to the surface of the powder bed; and
forming the second melt-solidified layer by scanning and irradiating an energy beam in a second direction which is parallel to the surface of the powder bed and intersects the first direction;
wherein a residual thickness of the first melt-solidified layer and a residual thickness of the second melt-solidified layer in the crystallographic texture are controlled by the steps of:
when forming the first melt-solidified layer, adjusting a first accumulation thickness of the powder bed and a first heat input amount of the energy beam irradiated to the powder bed to control a layer thickness of the first melt-solidified layer and a penetration depth of the first melt-solidified layer; and
when forming the second melt-solidified layer, adjusting a second accumulation thickness of the powder bed and a second heat input amount of the energy beam irradiated to the powder bed to control a layer thickness of the second melt-solidified layer and a penetration depth of the second melt-solidified layer; and
wherein the first heat input amount is controlled by adjusting an angle α1 between the first direction and a direction of the gas flow, and the second heat input amount is controlled by adjusting an angle α2 between the second direction and the direction of the gas flow.

2. The manufacturing method for a layered structure according to claim 1,
wherein one of the angles α1 and α2 is adjusted to 45° or more and 90° or less, and the other is adjusted to 0° or more and 45° or less.

3. The manufacturing method for a layered structure according to claim 1,
wherein the layered structure includes only the first melt-solidified layer or the second melt-solidified layer, and
wherein the layered structure further includes a crystallographic texture in which multiple first melt-solidified layers are layered or multiple second melt-solidified layers are layered in the thickness direction.

4. The manufacturing method for a layered structure according to claim 1,
wherein the manufacturing method further includes:
irradiating an energy beam while scanning in a third direction that is parallel to the surface of the power bed and intersects with the first direction and the second direction to produce a third melt-solidified layer, and manufacturing a layered structure which includes at least one third melt-solidified layer and which further includes a crystallographic texture in which multiple third melt-solidified layers are layered in the thickness direction
